(19) United States
(12) Patent Application Publication
(10) Pub. No.: US 2020/0211305 A1
(43) Pub. Date: Jul. 2, 2020

(54) AUTHORIZED ACCESS EVALUATION AND REMEDIATION SYSTEM

(71) Applicant: International Business Machines Corporation, Armonk, NY (US)

(72) Inventors: Michael Bender, Rye Brook, NY (US); Shilpa S. Shetty, Bangalore (IN); Stan K. Daley, Atlanta, GA (US); Kedar J. Daptardar, Naugatuck, CT (US)

(21) Appl. No.: 16/237,772

(22) Filed: Jan. 2, 2019

(51) Int. Cl. G07C 9/00; G06N 20/00; G06N 7/00

(52) U.S. Cl. CPC G07C 9/00158; G06N 7/005; G06N 20/00

(57) ABSTRACT

Systems, methods, and computer program products leveraging data analytics, machine learning, biometrics and blockchain technologies to track, modify and validate compliance with the rules governing access to regulated locations. Rules are ingested from data sources, based on the locations described by a travel itinerary, and rule requirements are generated based on the ingested rules. Traveler can upload each of the required travel documents to a blockchain, secured using biometric data locked to the traveler's identity. The rule requirement progress is monitored, and a remediation report is generated to guide the traveler's actions toward meeting each rule requirement prior to the scheduled itinerary being implemented. On the date of arriving at the destinations scheduled on the itinerary, agents or officials authorizing access to the location can retrieve documents uploaded to the blockchain by scanning the traveler and matching biometric data to the identity data stored by the blockchain.

### TECHNICAL FIELD

The present disclosure relates generally to the field of data processing systems and more specifically to cognitive data processing systems to predict, track, and complete access requirements for entering a physical location.

### BACKGROUND

Blockchain technology is a data structure that operates as a public ledger of electronic transactions. The transactions are bundled into blocks. Every block includes a timestamp and a reference to the previous block of the chain in the form of a hash, to assist with establishing a sequence of events. Every time a new transaction is initiated, a block is created describing the transaction details and it is broadcast to all the nodes of a public network maintaining the blockchain. Once the authenticity of the transaction is established, that block is linked to the previous blocks in the blockchain.

The chain of blocks is replicated across the entire public network, and all cryptographically secured. Every time a transaction occurs, the blockchain is replicated across the network and is publicly viewable for everyone to see. The integrity of the entire blockchain is maintained because each block refers to or includes a cryptographic hash value of the prior block. Once data has been written to a blockchain, it becomes virtually immutable. The data stored by the blocks can be altered, however, to do so requires collaboration between the transacting parties. Accordingly, a blockchain cannot be easily corrupted by fraudulently altering any unit of information on the blockchain. Since the each of the blocks are linked together and distributed across a public network, in order to successfully alter a block in a blockchain, an enormous amount of computing power would be required to override the entire public network responsible for maintaining the blockchain.

### SUMMARY

A first embodiment of the present disclosure provides a computer-implemented method comprising the steps of analyzing a scheduled itinerary for timing requirements and location information; ingesting rules data describing rules or laws of a region corresponding to the location information; creating rule requirements based on the rules data; comparing each document submitted by a traveler with the rule requirements; and generating a remediation report comprising a description of each document of the rule requirements that is deficient or missing and a projected timeline for complying with the rule requirements within the timing requirements of the scheduled itinerary.

A second embodiment of the present disclosure provides a computer system comprising a processor, a computer-readable storage media coupled to a processor, wherein the computer readable storage media contains program instructions executing a computer-implemented method comprising the steps of: analyzing a scheduled itinerary for timing requirements and location information; ingesting rules data describing rules or laws of a region corresponding to the location information; creating rule requirements based on the rules data; comparing each document submitted by a traveler with the rule requirements; and generating a remediation report 570 comprising a description of each document of the rule requirements that is deficient or missing and a projected timeline for complying with the rule requirements within the timing requirements of the scheduled itinerary.

A third embodiment of the present disclosure provides a computer program product comprising one or more computer readable storage media having computer-readable program instructions stored on the one or more computer readable storage media, said program instructions executes a computer-implemented method comprising the steps of: analyzing a scheduled itinerary for timing requirements and location information; ingesting rules data describing rules or laws of a region corresponding to the location information; creating rule requirements based on the rules data; comparing each document submitted by a traveler with the rule requirements; and generating a remediation report comprising a description of each document of the rule requirements that is deficient or missing and a projected timeline for complying with the rule requirements within the timing requirements of the scheduled itinerary.

### BRIEF DESCRIPTION OF THE DRAWINGS

FIG. 1 depicts a functional block diagram describing an embodiment of a computing environment in accordance with the present disclosure.

FIG. 2 depicts a block diagram describing a workflow of a computing environment executing a computerized method for tracking and validating compliance requirements for entering a location.

FIG. 3 depicts an embodiment of a cloud computing environment in accordance with the present disclosure.

FIG. 4 depicts an embodiment of abstraction model layers of a cloud computing environment, in accordance with the present disclosure.

FIG. 5a depicts an embodiment of a scheduled itinerary being displayed as part of a graphical user interface (GUI) by a traveler's device, in accordance with the present disclosure.

FIG. 5b depicts an embodiment of a GUI displayed by a traveler's device, enabling the upload of documentation in accordance with the present disclosure.

FIG. 5c depicts an embodiment of a remediation report being reported via a GUI of a traveler's device, in accordance with the present disclosure.

FIG. 6a depicts an alternative embodiment of a scheduled itinerary being displayed by a traveler's device, in accordance with the present disclosure.

FIG. 6b depicts an alternative embodiment of a GUI enabling the upload of documentation in accordance with the present disclosure.

FIG. 6c depicts an alternative embodiment of a remediation report being reported via a GUI of a traveler's device, in accordance with the present disclosure.

FIG. 7a depicts flow diagram describing an embodiment of an algorithm performing a computer implemented method in accordance with the present disclosure.

FIG. 7b is a continuation of the flow diagram of FIG. 7a, describing the embodiment of the algorithm performing the computer implemented method in accordance with the present disclosure.

FIG. 8 depicts an embodiment of a block diagram of internal and external components of a computer system in accordance with the embodiments of the present disclosure.

### DETAILED DESCRIPTION

Overview

International travel and business are some of the key contributors to a burgeoning travel and tourism sector throughout the world. As international travel increases, countries often regulate requirements for entering the country. Traveling internationally can be particularly daunting, since each country may impose their own laws, rules, regulations and requirements restricting the flow of individuals entering the country based on a traveler's itinerary and citizenship. Obtaining the proper documentation, visas, permissions and other credentials to access a regulated or restricted location may be time dependent, with only a limited window of availability before requiring access to the physical location. Moreover, each region or country's' laws and regulations may change regularly or even suddenly. International travelers who may be planning to travel or are scheduled to travel, may be unaware of the latest laws, rules and regulations implemented by each region of the world or fully understand the impact of how sudden or gradual changes to the laws, rules and regulations could impact access to a region while traveling. Accordingly, proper planning and coordination may be considered prudent to verify that the proper documents are obtained or can be obtained in a timely fashion before planning to travel to the restricted or regulated location.

Embodiments of the present disclosure recognize the dynamic nature of governmental security and the laws, rules and regulations that may be implemented to achieve a country or region's security goals. If a traveler does not comply with or address the laws, rules and regulations of a particular region, the compliance failures can result in delays or denied access to the region at various locations along a traveler's path, including airport check-ins and border crossings. Accordingly, such delays and denials may disrupt businesses, stymie international cooperation and cause a significant financial impact on the individuals involved.

Embodiments of the present disclosure leverage the technologies such as data analytics, machine learning, biometrics and blockchains to create secure systems, computer-implemented methods and computer program products for tracking, modifying and validating compliance with requirements for accessing one or more countries, regions or locations that may be subject to restrictions based on laws, rules or regulations. The embodiments of the disclosure described herein, may create a travel itinerary which may describe one or more regions or locations that the traveler may plan to access on a particular date in the future. Embodiments of the present disclosure may analyze the created itinerary for travel details, including location information describing the traveler's travel route, timing requirements, including information such as the date and time the traveler may be departing or arriving in one or more of the scheduled locations and personalized information that may be unique to the traveler, such as whom the traveler is traveling with, the relationship to another traveler, the traveler's name, address, residency or country of citizenship. Embodiments of the present disclosure may provide options for a user to opt-in or opt-out of features described herein, including features that may be implemented for tracking or monitoring of the traveler's activity with respect to the traveler's itinerary. In some embodiments of the present disclosure may provide notifications to the traveler when the traveler's information is collected, tracked or used.

Each of the locations a traveler may anticipate visiting or entering in accordance with the scheduled itinerary, may be governed by various local rules, laws or regulations (hereinafter may be referred to together generally as “rules”). The application of the rules may be complex and may vary based on the personalized information provided by the traveler and the travel route selected by the traveler. Embodiments of the present disclosure may accommodate for the complexities of the various rules that may apply by accessing one or more data sources 159 storing rule data 161 describing one or more of a region's or location's rules that may be relevant to the implementation of the scheduled itinerary. The rule data 161 retrieved from the data sources 159, may be stored by the systems described herein and analyzed using one or more artificial intelligence (AI) algorithms and/or machine learning techniques in order to properly determine which rules are applicable to the traveler and the requirements that may need to be fulfilled (i.e. by providing supporting documentation). Based on the conclusions drawn about applicable rules and the analysis thereof, the embodiments of the present disclosure may generate a set of rule requirements to track a traveler's compliance with said rules, including compliance by submission of any documentation or information that may be necessary to comply with the rules of a particular location or region. A traveler or registered agent representing the issuing authority may submit, or upload one or more documents being tracked by the rule requirements. As documents are submitted, embodiments of the present disclosure may analyze the documents or information being submitted, compare the uploaded documents and information to the rule requirements and generate a report based on the comparison of submitted documentation against the rule requirements. The report may inform the traveler of the remaining rule requirements that may need to be fulfilled prior to executing the scheduled itinerary (referred to herein as a “remediation report 570”), the probability of completing each rule requirement within the timing requirements set forth by the itinerary, for example the travel dates, and steps to remediate the current deficiencies of the rule requirements by the traveler.

In some embodiments of the present disclosure, the documents or information being uploaded, and/or the rule requirements, may be transmitted to a secure storage repository 140, such as a blockchain 141. Embodiments of the secure storage repository 140 may be secured or locked using identity data 147, which may prevent others from accessing the data stored by the secure storage repository 140, unless the identity data 147 is presented. Examples of identity data 147 can include access credentials such as a name and password combination, an identification number, a passkey and/or biometric data such as fingerprints, facial recognition, voice imprint, retina scan, iris scan, gait recognition, signature recognition, etc. A third party tasked with verifying the completion of one or more requirements of the rule requirements, such as a government agency, enterprise or other verifying entity that may be confirming compliance with a region or locations rules, may access the blockchain 141 or other secure storage repository 140 by entering the credentials acting as the identity data 147. In an instance where biometric data may be used to secure the document data 145, a third party may scan the traveler for identity data 147 using a biometric system 153 when the traveler arrives at a location described by the scheduled itinerary. For example, a Transportation Security Administration (TSA) agent screening travelers entering a US airport may scan the traveler to collect biometric data to access the secure storage repository 140 maintaining the document data 145 required to complete the rule requirements of the location or region. By successfully matching the scanned identity data 147 to the identity data 147 stored by the blockchain 141 or other secure storage repository 140, the agent responsible with ensuring compliance with the rules of the region or location may retrieve the uploaded document data 145 from the blockchain 141 or other secure storage repository 140 and ascertain whether all requirements have been met at the time of inspection by the agent. In some embodiments, any deficiencies in the document data 145 or missing rule requirements may be alerted or brought to the attention of the agent conducting the inspection of the document data 145.

In some embodiments of the present disclosure, a traveler's progress may be tracked and the probability of meeting the rule requirements may be predicted and reported, either continuously or periodically to the traveler. By tracking the traveler's progress to meet the rule requirements, remediation of rule requirements' deficiencies may be possible in order to ultimately comply with the rule requirements within the timing requirements of the scheduled itinerary. Moreover, continuously tracking a traveler's progress toward meeting the rule requirements may further allow for determinations to be made whether or not an adjustment to the scheduled itinerary may be required to address any outstanding requirements of the rules, or whether an alternative travel route and other permutations of the itinerary may need to be implemented, possibly to avoid rule requirements that may be onerous or unlikely to be met within the timing requirements of the scheduled itinerary.

Embodiments of the present disclosure may predict the probability of a traveler meeting the rule requirements within the temporal requirement of the scheduled itinerary by running one or more simulations based on a current set of documentation uploaded by the traveler or a third party tasked with managing the traveler's documentation. Embodiments of the present disclosure may accurately calculate probabilities by retrieving processing time data 157 from one or more accessible processing system 155. Processing time data 157 may be scraped from the one or more processing system 155, such as a server that may be responsible performing a particular transaction using one or more pieces of document data 145. For example, a processing system 155 may include one or more publicly accessible government computer systems responsible for processing travel visas, passports, access credentials, clearances, etc.

Processing time data 157 may be collected for a recent period of time, relative to the point in time one or more transactional processing requests may be requested. For example, time periods may be within the last week, month, six months, etc. from an expected point in time a traveler may be expected to make a processing request. The average or median processing time to complete a certain transaction may be compared with the time remaining before the deadlines of the scheduled itinerary are imposed. Based on the average or median processing times, the embodiments of the present disclosure may predict the likelihood that a requirement of the rules is submitted, processed and issued prior to the deadlines of the scheduled itinerary.

For example, a foreign country's consulate may be responsible for issuing travel visas. The average time for issuing travel visas needed by a traveler, based on the most recent processing time data 157 scraped from the consulate's public servers may be estimated at four weeks. However, the traveler may be traveling to the foreign country in two weeks, making the probability that obtaining the visa in time may be considered possible but still a low probability of occurring. Likewise, if the remaining time for fulfilling the rule requirements is six months, there may be a very high probability of acquiring the visa before traveling to the foreign country, since the estimated processing time is only 4 weeks. Based on the simulations performed using the acquired processing time data 157, and the reports generated therefrom, a traveler may be able to more accurately understand the requirements not currently being met in order to access a particular location or region, determine whether or not there is a likelihood that such deficiencies can be cured prior to attempting to access the regions or locations and whether or not there may be risks associated with failing to properly meet all the rule requirements prior to arriving in a region or location.

In alternative embodiments, additional statistical analysis of the processing time data 157 may be performed. For example, the processing time data 157 may be graphed based on the length of each previously known processing time and frequency of each known processing time occurring within the set of processing time data 157 retrieved for a particular period of time, allowing for a probability of achieving a processing time of a particular length of time to be calculated.

System for Tracking and Validating Access Requirements

Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure. A more complete understanding of the present embodiments and advantages thereof may be acquired by referring to the following description taken in conjunction with the accompanying drawings, in which like reference numbers indicate like features.

As a preface to the detailed description, it should be noted that, as used in this specification and the appended claims, the singular forms “a”, “an” and “the” include plural referents, unless the context clearly dictates otherwise.

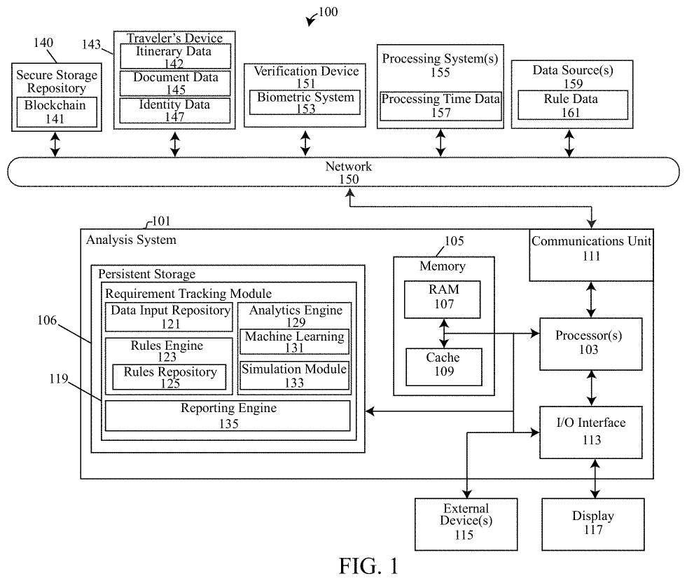

Referring to the drawings, FIGS. 1-6c depict diagrams of a computing environment 100, 200, 350 capable of tracking, predicting and validating a traveler's success or failure to meet the requirements for accessing a region or location that may be subject to one or more restrictions, in accordance with the embodiments of the present disclosure. Embodiments of computing environment 100, 200, 350 may include a plurality of computer systems and devices interconnected via a computer network 150, such as analysis system 101, secure storage repository 140, traveler's device 143, verification device 151, one or more processing system 155 and one or more data sources 159. Embodiments of the analysis system 101, secure storage repository 140, traveler's device 143, verification device 151, one or more processing system 155 and one or more data sources 159 may each be a specialized computer system comprising specialized configurations of hardware, software or a combination thereof, as shown and described in FIGS. 1-6c of the present disclosure and in the embodiments described herein.

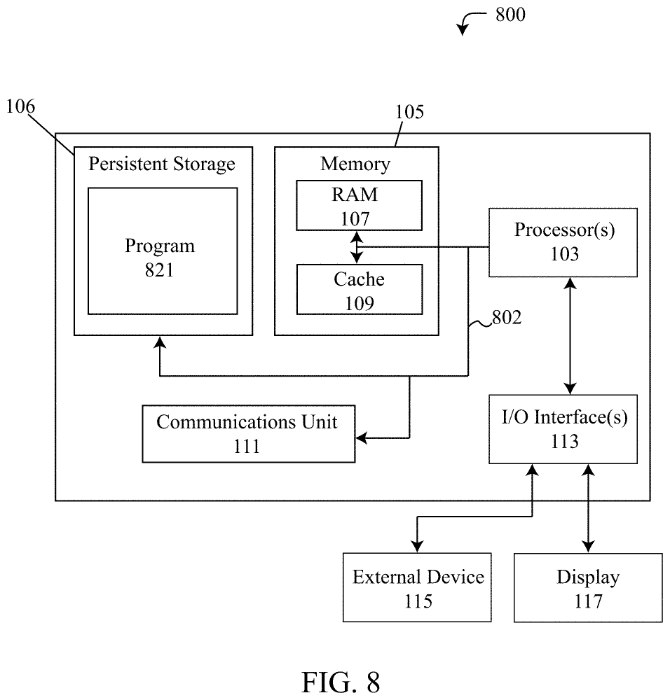

Embodiments of the analysis system 101, secure storage repository 140, traveler's device 143, verification device 151, one or more processing system 155 and one or more data sources 159 may not only comprise the elements of the systems and devices depicted in FIGS. 1-6c but may also incorporate one or more elements of a computer system 800, as shown in FIG. 8 and described in the COMPUTER SYSTEM section below. One or more elements of the computer system 800 may be integrated into the specialized computer systems of computing environment 100, 200, 350 including the analysis system 101, secure storage repository 140, traveler's device 143, verification device 151, one or more processing system 155 and the computer systems maintained as a data source 159.

Embodiments of the analysis system 101, secure storage repository 140, traveler's device 143, verification device 151, processing system 155, data sources 159 and other network accessible systems may operate as desktop computers, laptop computers, tablet computers, smartphones, server computers, wearable accessories such as smart watches, smart glasses, or any other computer system known in the art. In some embodiments of the computing environments 100, 200, 350 the analysis system 101, secure storage repository 140, traveler's device 143, verification device 151, processing system 155, data sources 159 and other network accessible systems, may represent computer systems utilizing clustered computers and components to act as a single pool of seamless resources when accessed through network 150. For example, such embodiments may be used in data center, cloud computing, storage area network (SAN), and network attached storage (NAS) applications.

Embodiments of the analysis system 101, secure storage repository 140, traveler's device 143, verification device 151, processing system 155, data sources 159 and other network accessible systems may each be connected and placed into communication with one another over a computer network 150. Embodiments of the computer network 150 may be constructed using wired, wireless or fiber optic connections. As shown in the exemplary embodiments, the analysis system 101, secure storage repository 140, traveler's device 143, verification device 151, processing system 155, data sources 159 and other network accessible systems, may connect and communicate over the network 150 using a communications unit 111, such as a network interface controller or other network communication hardware. Embodiments of the communications unit 111 may implement specialized electronic circuitry allowing for communication using a specific physical layer and a data link layer standard. For example, Ethernet, Fiber channel, Wi-Fi or Token Ring.

Communications unit 111 may further allow for a full network protocol stack, enabling communication over network 150 to the group of computer systems or other computing hardware devices linked together through communication channels. The network 150 may facilitate communication and resource sharing among analysis system 101, secure storage repository 140, traveler's device 143, verification device 151, processing system 155, data sources 159 and other network accessible systems connected to the network 150 (for example, network accessible storage media). Examples of network 150 may include a local area network (LAN), home area network (HAN), wide area network (WAN), back bone networks (BBN), peer to peer networks (P2P), campus networks, enterprise networks, the Internet, cloud computing networks and any other network known by a person skilled in the art.

Cloud computing networks are a model of service delivery for enabling convenient, on-demand network 150 access to a shared pool of configurable computing resources (e.g., networks, network bandwidth, servers, processing, memory, storage, applications, virtual machines, and services) that can be rapidly provisioned and released with minimal management effort or interaction with a provider of the service. A cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network 150 and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment 350 is service oriented with a focus on statelessness, low coupling, modularity, and semantic interoperability. At the heart of cloud computing is an infrastructure that includes a network 150 of interconnected nodes 310.

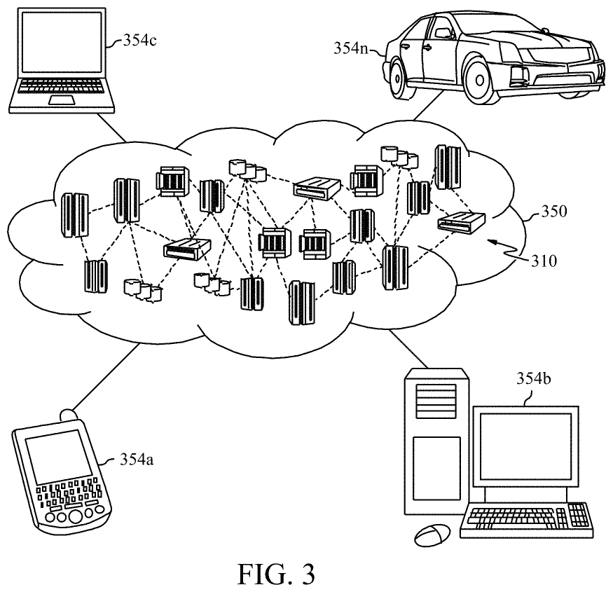

Referring to the drawings, FIG. 3 is an illustrative example of a cloud computing environment 350. As shown, cloud computing environment 350 includes one or more cloud computing nodes 310 with which local computing devices used by cloud consumers, such as for example, a personal digital assistant (PDA) or cellular telephone 354a, desktop computer 354b, laptop computer 354c and/or automobile computer system 354n may communicate. Nodes 310 may communicate with one another and may be grouped (not shown) physically or virtually, in one or more networks 150, such as Private, Community, Public, or Hybrid clouds as described hereinabove, or a combination thereof. This allows cloud computing environment 350 to offer infrastructure, platforms and/or software as services for which a cloud consumer does not need to maintain resources on a local computing device. It is understood that the types of local computing devices connected cloud computing environment 350, are intended to be illustrative only and that computing nodes 310 and cloud computing environment 350 can communicate with any type of computerized device over any type of network 150 and/or network addressable connection (e.g., using a web browser).

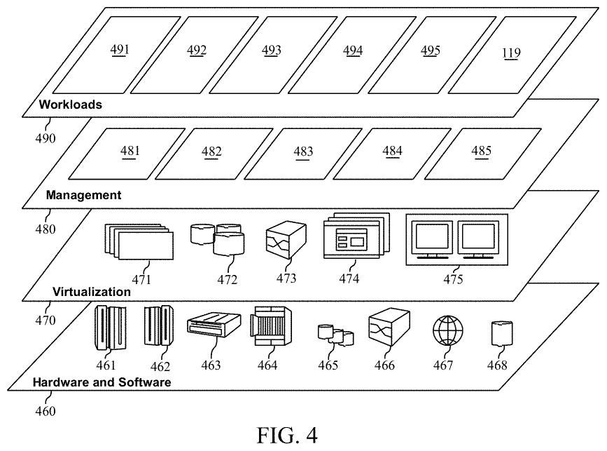

Referring now to FIG. 4, a set of functional abstraction layers provided by cloud computing environment 350 is shown. It should be understood in advance that the components, layers, and functions shown in FIG. 4 are intended to be illustrative only and embodiments of the invention are not limited thereto. As depicted, the following layers and corresponding functions are provided:

Hardware and software layer 460 includes hardware and software components. Examples of hardware components include: mainframes 461; RISC (Reduced Instruction Set Computer) architecture-based servers 462; servers 463; blade servers 464; storage devices 465; and networks and networking components 466. In some embodiments, software components include network application server software 467 and database software 468.

Virtualization layer 470 provides an abstraction layer from which the following examples of virtual entities may be provided: virtual servers 471; virtual storage 472; virtual networks 473, including virtual private networks; virtual applications and operating systems 474; and virtual clients 475.

In one example, management layer 480 may provide the functions described below. Resource provisioning 481 provides dynamic procurement of computing resources and other resources that are utilized to perform tasks within the cloud computing environment 350. Metering and pricing 482 provide cost tracking as resources are utilized within the cloud computing environment 350, and billing or invoicing for consumption of these resources. In one example, these resources can include application software licenses. Security provides identity verification for cloud consumers and tasks, as well as protection for data and other resources. User portal 483 provides access to the cloud computing environment 350 for consumers and system administrators. Service level management 484 provides cloud computing resource allocation and management such that required service levels are met. Service Level Agreement (SLA) planning and fulfillment 485 provide pre-arrangement for, and procurement of, cloud computing resources for which a future requirement is anticipated in accordance with an SLA.

Workloads layer 490 provides examples of functionality for which the cloud computing environment may be utilized. Examples of workloads and functions which may be provided from this layer include: mapping and navigation 491, software development and lifecycle management 492, virtual classroom education delivery 493, data analytics processing 494, transaction processing 495, and the requirement tracking module 119.

Referring back to FIG. 1, embodiments of the computing environments 100, 200, 350 described herein may include an analysis system 101, The analysis system 101 may include one or more processes, services, engines and/or modules specializing in performing one or more specific tasks or functions associated with tracking, remediating and verifying a traveler's varying stages of compliance with one or more rules, regulations and laws before attempting to gain access to a regulated, restricted or controlled location or region. Embodiments of the analysis system 101 may be equipped with a requirement tracking module 119. The term “module” may refer to a hardware module, software module, or a module may be a combination of hardware and software resources. A module (whether hardware, software or a combination thereof) may be designed to implement or execute one or more specific tasks, routines or functions. Embodiments of hardware-based modules may include self-contained components such as chipsets, specialized circuitry, one or more memory 105 devices and/or persistent storage 106. A software-based module may be part of a program 821, program code or linked to program code containing specific programmed instructions loaded into a memory 105 device or persistent storage 106 device of a computer system operating in computing environment 100, 200, 350 as exemplified in the drawings or the embodiments described herein.

Embodiments of the analysis system 101, including any sub-systems, processes, services, engines and/or modules, whether hardware, software, or a combination thereof, may perform the functions and tasks associated with tracking, remediating and verifying a traveler's successful compliance with the rules, laws and regulations in order to access a location or region. More specifically, embodiments of the analysis system 101 may include a requirement tracking module 119 which may perform one or more functions or tasks associated with analyzing itineraries created by travelers (or third parties) for itinerary data 142 describing relevant travel information, including the timing, locations, destinations, travel routes, travel reasons and other useful information for determining which rules may apply, retrieve the most up-to-date and relevant rule data 161 from one or more accessible data sources 159, and create a set of rule requirements using the rule data 161, based on the analysis of the itinerary data 142. Embodiments of the requirement tracking module 119 may further enable travelers to upload supporting documentation in an effort to comply with the rule requirements and generate a remediation report that may successfully diagnose missing or deficient supporting documentation, as well as guide a traveler how to correct such deficiencies in order to fully comply with the rule requirements prior to the travel dates set by the traveler's itinerary. Embodiments of the requirement tracking module 119 may include a plurality of components, sub-modules, engines, and other features that may be dedicated to performing one or more of the specific tasks of the requirement tracking module 119. For example, in some embodiments, the requirement tracking module 119 may include a data input repository 121, rules engine 123, rules repository 125, analytics engine 129, machine learning module 131, simulation module 133 and reporting engine 135.

Referring to the drawings, FIG. 1 depicts an embodiment of the requirement tracking module 119, which may comprise a data input repository 121 as shown. The data input repository 121 may perform the function or task of creating, receiving, storing, formatting and/or organizing data created by, inputted into, or transmitted to the analysis system 101. The data stored within the data input repository 121 may be shared with other computer components of the requirement tracking module 119, and/or one or more computer systems connected to the network 150, such as the verification device 151, traveler's device 143, and secure storage repository 140. Examples of data that may be maintained by the data input repository 121 may include itinerary data 142, document data 145, identity data 147 and/or processing time data 157.

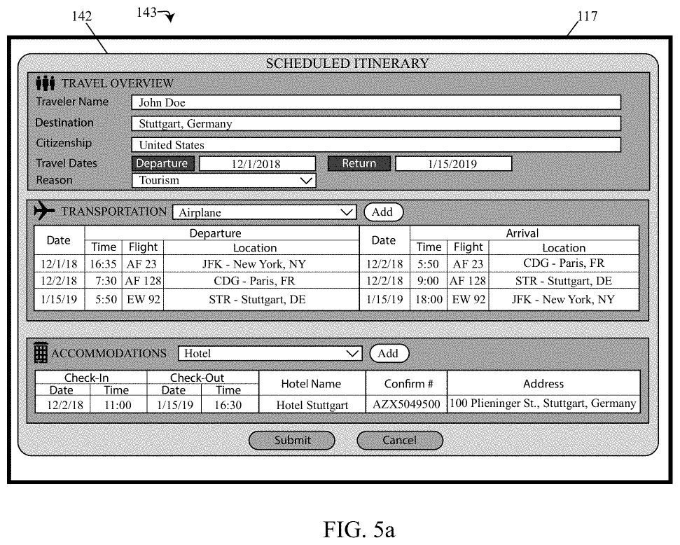

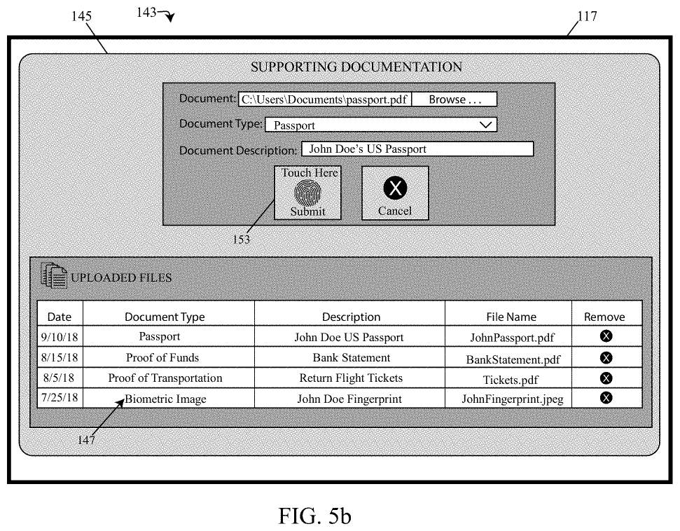

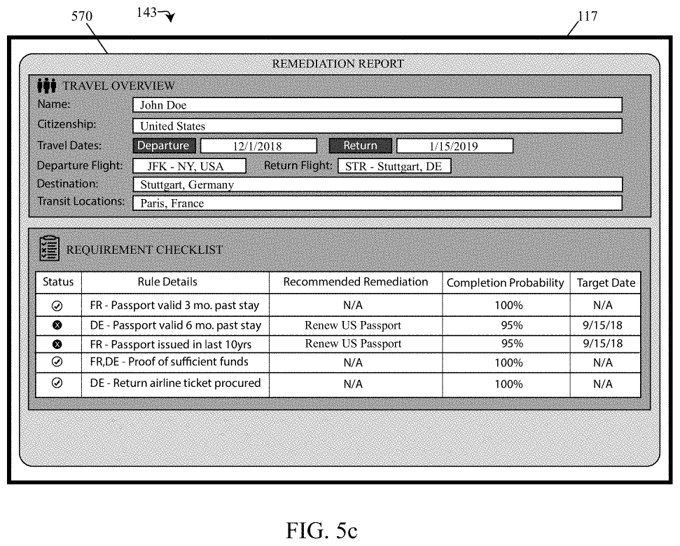

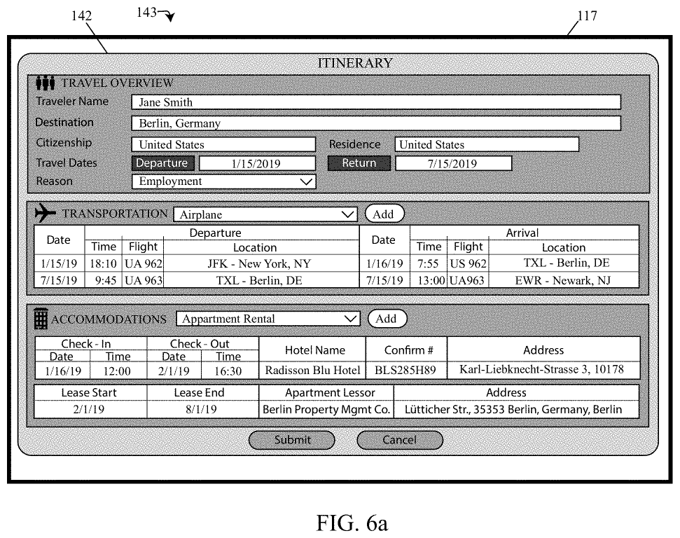

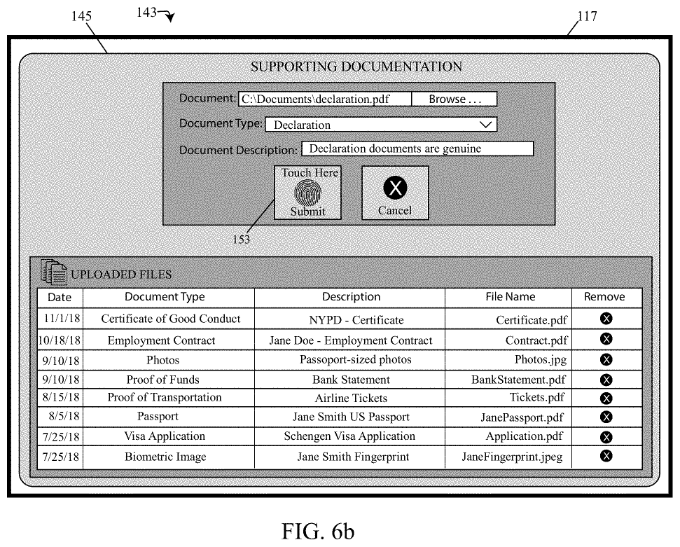

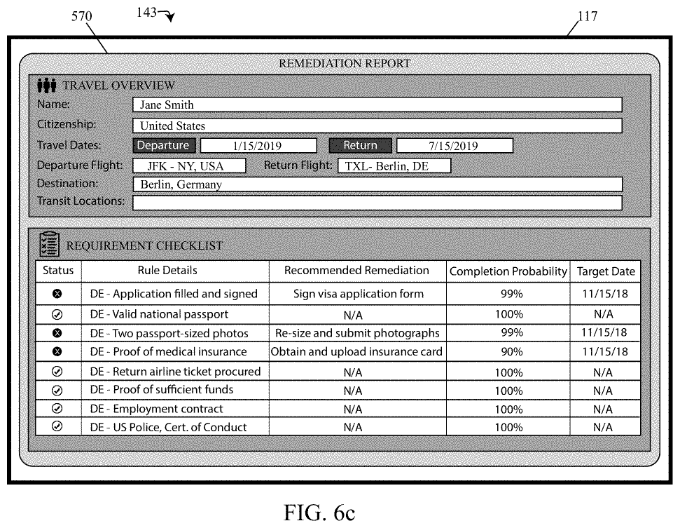

Embodiments of itinerary data 142 may be described as data that may be inputted into an itinerary created by a traveler or third party, via a traveler's device 143, the analysis system 101 or a third-party computer system which may be connected to network 150. As shown in the examples of the itineraries in FIGS. 5a and 6a, itinerary data 142 can comprise data that may include identifying information describing the traveler, including the traveler's name, address, citizenship or residence. Moreover, itinerary data 142 may further comprise descriptive information about the traveler's plans or schedule to access one or more regions or locations. The itinerary data 142 may include data describing a traveler's destination, travel dates, length of stay, travel routes, any transitioning locations that may be visited, methods of travel, transportation schedules, lodging schedule, and reasons for traveling.

In some embodiments of the analysis system 101, document data 145 may be transmitted to and stored by the data input repository 121. Document data 145 may refer to the information stored within one or more supporting documents that may be uploaded or transmitted by a traveler or a trusted third party on behalf of the traveler, in order to meet one or more rule requirements for accessing a region or location. FIGS. 5b and 6b depict examples of different types of documents that may be submitted in order to meet one or more rule requirements for accessing or entering a location. For example, supporting documents that can contain document data 145 include (but are not limited to) passports, bank statements, visas, visa applications, access credentials (such as an access cards or IDs), insurance information, transportation tickets, photographs, contracts, letters, certificates, images, birth certificates, marriage licenses or any other document or file that may be known or used to verify or validate a traveler's right to access a region or location.

In some embodiments of the present disclosure, the document data 145 may be secured using identity data 147 to prevent unauthorized parties from improperly accessing the document data 145 being stored. Embodiments of identity data 147 may refer to information that may be used to uniquely identify a traveler. The identity data 147 may include confidential information about the traveler in some embodiments and may uniquely link the document data 145 to the traveler. For example, using a social security number or government issued identification number. In the exemplary embodiments, the identity data 147 may be biometric data which may be collected by one or more biometric systems 153, such as a biometric camera, microphone, scanner, fingerprint reader, optical readers or sensors, thermal readers, ultrasound readers, complimentary metal-oxide semiconductor (CMOS) readers, infrared cameras, etc. Embodiments of the biometric data may be uploaded to the analysis system 101, a secure storage repository 140 and/or locally stored by the traveler's device 143. Biometric data may be considered any type of data about a biological organism that may be used to identify said biological organism. In the case of a human traveler, the biometric data may identify unique human characteristics that may be specific to the traveler. For example, fingerprints, sections of DNA, ear shape, facial recognition, finger geometry recognition, gait, signature recognition, iris recognition, retina recognition, voice recognition, vein recognition, and/or typing recognition.

In some embodiments, in order to upload or access the supporting document data 145 that may be necessary to complete the rule requirements or allow for a third-party authority to confirm and verify compliance with the rule requirements, identity data 147 may be required to be submitted before obtaining access. For example, a security agent at the airport screening the traveler may use one or more biometric systems 153 to scan and collect identity data 147 from the traveler. The security agent may subsequently submit the identity data 147 as a form of credentials to gain access to the document data 145, in order to confirm compliance with each applicable rule set forth for the given location or region the security agent may be responsible for maintaining. The identity data 147 scanned by the agent can be matched to identity data 147 that was previously stored by the data input repository 121, secure storage repository 140 such as a blockchain 141 or other secure storage repository 140. Once a match has been made, the security agent or other third party may retrieve the document data 145 previously uploaded by the traveler (or third party).

Furthermore, in some embodiments, a traveler seeking to upload one or more supporting documents to the data input repository 121 or a secure storage repository 140 (such as a blockchain 141) may be prompted to supply identity data 147 in order to make the submission of the document data 145 to the data input repository 121, secure storage repository 140 or blockchain 141. For example, as shown in FIGS. 5b and 6b, in order to submit document data 145, a traveler can initiate the submission by touching a touchscreen display 117 that reads the traveler's fingerprint. Upon confirmation of the fingerprint as being a valid match with a fingerprint stored as the identity data 147, the document data 145 being provided may be uploaded to the data input repository 121, secure storage repository 140, blockchain 141 or other storage device configured to receive the document data 145. In alternative embodiments, instead of submitting a fingerprint, other biometric systems 153 may be installed to collect and confirm biometric data of the traveler prior to commencing the upload of document data 145.

Embodiments of the requirement tracking module 119 may further comprise a rules engine 123. Embodiments of the rules engine 123 may perform functions or tasks associated with retrieving, storing, maintaining, and administering one or more sets of rule data 161 for each itinerary based on an analysis and extraction of itinerary data 142 from each itinerary that is created or processed by the analysis system 101. The rules engine 123 may be described as an application that may manage decision-making processes of the analysis system 101 using pre-defined logic to determine outcomes based on the set(s) of rules stored by the rules repository 125. Embodiments of the rules engine 123 allow the analysis system 101 to make precise decision making based on the applicable rules, regulations and laws that may be applicable to a particular traveler, even when there may be complex dependencies or frequent rule changes that may require frequent logic changes. The pre-defined logic curated by the rules engine 123 may be modifiable, adjustable and updatable based on the rule data 161 ingested and stored. The rule data 161 retrieved and collected by the rules engine 123 may be stored by a rules repository 125 in some embodiments. In alternative embodiments, the data input repository 121 may store not only the data inputted into the analysis system 101 but also maintain rules data 161. The rules engine 123 may us automation to automatically update the existing rules stored in the rules repository 125 and apply the rule changes to each new itinerary created, as well as retroactively apply the updated rules to any currently pending itineraries that have not yet have been executed.

Embodiments of the rules engine 123 may ingest rule data 161 describing the rules, laws, regulations, etc., for each location or region that may be available to the analysis system 101. Embodiments of the rule data 161 may be used to generate a report describing each of the rule-based requirements to successfully travel to and/or access a particular region or location (referred to herein as “rule requirements”). Embodiments of rules engine 123 may build one or more databases of rules within the rules repository 125 by retrieving the rule data 161 describing one or more rules for a particular region or location, from one or more data sources 159 that may store and/or maintain the rule data 161. The rule data 161 may be kept up-to-date by periodically updating the current rules stored by the rules repository 125 for one or more regions or locations and/or retrieve updated rule data 161 at regularly scheduled intervals.

In some embodiments, updating the rule data 161 stored by the rules repository 125 may occur on an as-needed basis. For example, the analysis system 101 might receive a new itinerary created by a traveler and the analysis system 101 may determine that the traveler has scheduled to enter a particular region or location on a particular date and/or time. The rules engine 123 may query the rules stored by the rules repository 125 that are currently maintained by the analysis system 101, identify the rules that are applicable to the particular regions or locations described by the itinerary, determine the date that the currently stored rules were last created or updated, and/or whether such rules have expired or been replaced more recently. Embodiments of the rules engine 123 may connect to one or more data sources 159 responsible for storing or maintaining rule data 161 for the region or location of interest, retrieve said rule data 161 and compare the rule data 161 stored by the data sources 159 with the rule data 161 stored by the rules repository 125. In some embodiments, if the rule data 161 stored by the rules repository 125 is no longer up-to-date with the current rules of the region or location, the rules engine 123 may replace or overwrite the out-of-date rule data 161 with the rules data 161 retrieved from the data sources 159.

Embodiments of the data sources 159 accessible to the rules engine 123, may be any type of computer system, such as a server, which may be responsible for storing, maintaining, sharing and/or updating an official (or unofficial) set of rules, laws or regulations associated with one or more regions or locations. For example, the data source 159 can be an official government data source 159 in some instances or in other instances the data source 159 can be a computer system maintained by a third party that may monitor official government rule changes and provide a set of rules, laws or regulations describing the types of documents that should be provided in order for travelers to gain access to the region or location for a particular purpose or length of time. The government or a third-party maintaining the rule changes may update the data sources 159 each time the rule data 161 currently stored by the data source 159 becomes out of date and/or no longer accurate. Subsequently, the rules engine 123 may retrieve the rule data 161 describing the current rules for accessing the region or location, store rule data 161, and share the rule data 161 with other components of the requirement tracking module 119 that may be applying the rules to one or more itineraries that may be subject to the restrictions or requirements of the rules.

In some embodiments of the rules engine 123, the rules engine 123 may actively collect, characterize and store rule data 161 in a manner similar to a search engine. For example, by using AI algorithms to continuously visit various websites, web pages, social media, applications and other internet-accessible content that may be describing one or more rules, regulations and laws for accessing various locations and regions. For instance, the analysis system 101 may crawl across each country's governmental websites, immigration services agencies, embassies or consulate webpages and social media. As the analysis system crawls across the internet, rule data 161 may be parsed from the various data sources 159 visited, categorized, analyzed for keywords and metadata then stored for future reference by the rules repository 125.

While many of the examples described herein discuss the application of the computing environment 100, 200, 350 to traveling between regions, locations or countries, the embodiments of the present disclosure should not be construed as being strictly limited to international travel. The embodiments of the present disclosure may also be used to guide individuals seeking to obtain access credentials or permission to enter locations other than countries, as well as permission to individuals seeking to obtain access to information (such as through a government clearance or other access credentials). For example, a traveler may be seeking to gain access to a particular location maintained by an enterprise that might be restricted to a particular set of people allowed to enter, such as a research and development laboratory. A traveler seeking to enter such a restricted location maintained by an enterprise may be required to comply with the company's policy requirements and screening process before gaining access to the laboratory and thus may be required to apply for access credentials, including a submission of supporting documentation. In such a case where the location being requested to access is a restricted business location, the data source 159 describing the rules and maintaining rule data 161, may be a computer system or server owned, operated or maintained by the enterprise regulating access to the location. The enterprise may curate the rule data 161 and make the rule data 161 accessible to the analysis system 101. The enterprise may also regularly update the rule data 161 and alert the analysis system 101 when rules may have changed, prompting the rules engine 123 to update the rules stored by the rules repository 125 periodically or upon being alerted that rule changes may have been implemented.

Moreover, in some embodiments, an enterprise may utilize the analysis system 101 to identify employees who may be able to travel to a region or location on short notices, because the employee may already meet one or more of the rule requirements that might normally delay other employees from being able to travel. A simulation for multiple participants may be run by a business trying to identify at least one employee from a pool of employees that may be travel-eligible to meet a business need that includes international travel or special requirements. The business or other enterprise may be able to input an itinerary into the analysis system 101 and a report may be generated by the reporting engine 135 that may identify which employees from the pool of employees which may have previously uploaded document data 145, have already fulfilled one or more the rule requirement for the itinerary entered by the enterprise. From there, the enterprise may select one or more employees for a particular task that may require access to a particular location or region as part of the project.

In some embodiments of the analysis system 101, the rules engine 123 may further perform the function of retrieving and storing, within the rules repository 125, processing time data 157. Embodiments of processing time data 157 may be stored by one or more processing system 155 and/or by one or more data sources 159, which may also store the rule data 161. Processing time data 157 may comprise information describing a length of time that may have been previously recorded to complete a particular type of transaction that may have been previously performed by the processing system 155 or another computer system. For example, the processing system 155 could have been used to review applications for visas or issue other types of credentials in response to formal requests for the visas or credentials. The processing system 155 may track the processing time to complete the transaction by logging the date and time of receiving an initial transaction request, as well as the date and time the transaction request was completed. Embodiments of the analysis system 101 may request or scrape the transactional information from the processing system 155 as processing time data 157 and store said processing time data 157 for future use or reference when a traveler may be required to complete the same or similar transaction as the transaction that was previously performed by the processing system 155.

Embodiments of the processing time data 157 describing one or more past transaction may provide a reasonable time estimation for the analysis system 101, allowing the analysis system 101 to predict current timing requirements to complete the same or similar transaction by a traveler who may be attempting to presently complete the transaction as part of one or more rule requirements. For example, a traveler may be scheduled to travel to a foreign country that requires the completion and receipt of a travel visa for that foreign country. The analysis system 101 may retrieve and store processing time data 157 describing past transactions performed by one or more processing system 155 that have completed and issued previous applications of the visa for the same foreign country as the foreign country the traveler is scheduled to visit. By scraping the processing system 155 for the processing time data 157, the analysis system 101 (namely the analytics engine 129 described in detail below) may be able to estimate an accurate time frame that the traveler may expect to receive the visa based on the length of time the authority issuing said visas has completed the issuance of the visas in the past, as evident by the processing time data 157 and using the processing time data 157 as part of the training data for machine learning in order to teach the analysis system to accurately predict the time frame for completing the task.

In some embodiments of the analysis system 101, the collection and use of processing time data 157 may be filtered or refined to more accurately predict the processing time of future transactions. In some embodiments, the processing time data 157 can be filtered based upon a selected period of time. For instance, when estimating the length of time for completing a transaction of the rule requirements, an analytics engine 129 of the analysis system 101 may collect and analyze processing time data 157 of similar transactions from the last week, month, 3 months, 6 months, year, etc. For example, a traveler might be seeking to complete a visa application to visit a foreign country. The analysis system 101 may use processing time data 157 from processing system 155 that may have issued same visas for the foreign country the traveler is traveling to from the past 3 months to predict the current expected time to complete the visa application. The use of more recent processing time data 157 from the previous 3-month time period may be more relevant to predicting the processing time as opposed to using processing time data 157 from further in the past, such as the previous 10 years. In some embodiments, the analysis system 101 may predict the processing time for completing a particular transaction by calculating an average or median processing time from the processing time data 157, for the period of time selected by the analysis system 101.

When calculating processing times for completing transactions, the more recent the processing time data 157 may be more accurate for estimating processing time for completing the transaction, since the processing time data 157 may give insight into the current transactional delays that a processing authority may be experiencing at a given moment. For example, due to a heavy influx of requests, lack of resources to complete the requests in a timely manner or other reasons for delays. However, an analysis system 101 may also analyze and predict processing times for transactions based on a particular time of year or based on known patterns related to the transactional requests. For instance, international travel to particular locations in the world can be busier or slower depending on the time of the year, and the destinations. The analysis system 101 may be capable of predicting a timeframe for completing a transaction by the authority in charge thereof, based on the historical performance of the authority tasked with completing the transaction during similar times of the previous years. Moreover, the analysis system 101 may take into account the busy times and lulls exemplified by the historical processing time data 157 when making recommendations or setting target dates in a remediation report 570 tasked with assisting the traveler's completion of the rule requirements

The estimation of the processing time for completing a particular transaction, or a set of transactions, may be informative to a traveler and the analysis system 101 for determining whether or not the rule requirements set forth by the analysis system 101 may be feasible to complete prior travel dates set forth in the corresponding itinerary. For example, one of the rule requirements for traveling to a foreign country may be to submit a visa application and receive approval from an issuing authority approving the visa application prior to entering the foreign country. Based on historical processing time data 157, the estimated transaction completion time may be estimated to be approximately 4-6 weeks. However, in this example, a traveler's itinerary may have previously scheduled the traveler to enter the foreign country next month. Based on the estimated transaction time predicted by the analysis system 101, the probability of completing and receiving an issued visa within the next month could be considered a very low probability of occurring. Such a low probability of completion may be reported to the traveler and allow for the traveler to amend the traveler's itinerary and/or proceed to use other methods for obtaining the visa in time (i.e. such as using an expedited request or applying in person at the foreign country's US-based consulate, which the analysis system 101 may advise the traveler to do).

Embodiments the analysis system 101 may further comprise an analytics engine 129. The analytics engine 129 may perform the functions or tasks of the requirement tracking module 119 that may be directed toward generating a set of rule requirements based on the rules data 161 and the itinerary data 142 of each itinerary created or received by the analysis system 101. The term “rule requirements” may refer to a list of one or more steps or actions that a traveler may be required to complete in order to comply with each of the rules, regulations or laws of a particular region or location scheduled by the itinerary before a traveler is allowed to access the region or location. Whether or not each of the rules set forth by the rule requirements is necessary to complete before accessing the region or location may be dependent upon the region or location being accessed. Some regions or locations may have strict requirements for completing each of the rule requirements before obtaining access, whereas other regions or locations may not deny access to the region or location per se, but instead there may be a calculated risk associated with not complying with each of the rule requirements. In some embodiments of the analysis system 101, the amount of risk associated with being denied access to one or more particular regions for failing to comply with each rule of the rule requirements may be tracked over time. Using historical data from other travelers, the analysis system 101 may, in the remediation report 570 provided to the traveler, identify a probability or level of risk associated with being denied access to the region or location for failing to meet the rule requirements and present the risk to the traveler.

In order to meet each of the rule requirements, embodiments of the analysis system 101 may enable a traveler to submit or upload document data 145 to provide supporting documentation. In some embodiments, the document data 145 may be uploaded directly to the analysis system 101. In the exemplary embodiment, the analysis system 101 may enable a traveler to upload document data 145 from a traveler's device 143 to a secure storage repository 140 which may maintain a blockchain 141 or other secured storage system. By uploading the document data 145 to a secure storage repository 140, the document data 145 may become readily accessible to authorized authorities that may manage and verify a traveler has met the rule requirements to access a location or region. In the exemplary embodiments, the use of biometric data may lock a block in a blockchain 141 containing the traveler's document data 145 to the specific traveler. An authorized authority, such as a government agent, interviewing travelers at an airport, train station, as a traveler crosses a country's border in a vehicle or on foot, or along any other travel point of the scheduled itinerary, the authorized authority may obtain access to the blockchain 141 by scanning a traveler's biometric data using a verification device 151 comprising a biometric system 153 and matching the traveler's biometric data scanned by the verification device 151 to the identity data 147 stored by the blockchain 141.

Embodiments of a blockchain 141 may allow for digital information (in this case document data 145, identity data 147 and the rule requirements to access a region or location) to be stored along a distributed network and publicly accessible, verifiable, but not unable to be copied. The information and data stored by the blockchain 141 may be reconciled into a database that may be stored in multiple locations and may be updated instantly. For example, by the traveler uploading additional document data 145. The traveler's information for a particular itinerary may form a block (a record) within the blockchain 141. When the traveler uploads document data 145 to the block for the first time, the block may be added to the blockchain 141. The block's owner, in this case, the traveler, may be provided a complex key in order to access the specific address of the block within the blockchain 141 that comprises the traveler's data for a particular scheduled itinerary. In the exemplary embodiment, the complex key may be the traveler's identity data 147 and matching the identity data 147 using biometric systems 153 may unlock access to the specific block of interest in the blockchain 141, whether by the traveler themselves to update the data being stored, the analysis system 101 tracking the progress of the traveler to meet the rule requirements or an authorized authority verifying compliance with the rule requirements.

FIG. 5b and FIG. 6b provide an example of an interface being displayed by a touchscreen display 117 of a traveler's device 143 capable of uploading document data 145 to a secure storage repository 140 in order to meet rule requirements. In the embodiment depicted in FIG. 5b and FIG. 6b, a traveler may select one or more files comprising document data 145, a document type and provide a description for the supporting documentation being uploaded. In some embodiments, the specific types of documentation required to be provided by the traveler may be pre-entered into interface and the types of documents that may be visible via the interface may be limited strictly to the documents required to meet the rule requirements for a particular itinerary of a traveler. For example, in FIG. 5b, the traveler may be limited to providing supporting documentation that is considered necessary based on the itinerary set forth in FIG. 5a. In this example of FIG. 5a-5b, a US citizen traveling to Germany for less than 90 days, with a layover in France has only minimal rule requirements to meet in order to access Germany and layover in France, specifically, supporting documentation may include a valid US passport, proof of sufficient funds and return transportation back to the US. Accordingly, the interface may specifically limit the types of documents being provided to only those required by the rule requirements.

In contrast to the itinerary shown in FIG. 5a, the itinerary of FIG. 6a may be analyzed and identified as having more complex set rule requirements to meet, despite the traveler still being scheduled to travel from the US to Germany. Since the itinerary has scheduled the travel to Germany for more than 90 days, the analysis system 101 may recognize the additional requirements triggered by the length of the stay and adjust the rule requirements and the types of documents that may be uploaded via the interface accordingly. For example, in addition to enabling the upload of the passport, proof of funds, and proof of transportation, the interface may further allow a traveler to select additional document types to upload that may be required to complete the rule requirements, including (but not limited to) a signed visa application, photos, employment contract, a certificate of good conduct issued by a local police authority and a declaration attesting that the documents submitted are true and accurate.

Embodiments of the analytics engine 129 may incorporate the use of mathematics, statistics, predictive modeling and machine learning techniques to find meaningful patterns in the data stored by the data input repository 121, rules repository 125 and/or a secure storage repository 140 such as blockchain 141. More specifically, the analytics engine 129 may analyze the itinerary data 142 being ingested into the data input repository 121 and apply one or more machine learning techniques to the itinerary data 142 to discover and extract information from the identity data 147 that may guide the analytics engine 129 toward identifying the relevant rules that may be applicable for the itinerary being analyzed. For example, the analytics engine 129 may parse the itinerary data 142 for relevant information, such as the descriptions of one or more regions or locations scheduled to be accessed by the traveler, the dates travel is scheduled to occur, reasons for traveling, the length of time a traveler may be accessing the region or location, any secondary locations or regions that may be accessed during the traveler's itinerary which may have separate rules, regulations or laws, methods of travel being employed, as well as any scheduled accommodations such as any hotel listings, hostels, friends or family addresses, etc.

Embodiments of the analytics engine 129 may implement machine learning or other AI algorithms, for example via a machine learning module 131. Embodiments of machine learning techniques that may be implemented by the machine learning module 131 may include supervised learning, unsupervised learning and/or semi supervised learning techniques. Supervised learning is a type of machine learning that may use one or more computer algorithms to train the machine learning module 131 using labelled examples during a training phase. The term labelled example, may refer to the fact that during the training phase, there may be a desired input that will produce a known desired output by the machine learning module 131. The algorithm of the machine learning module 131 may be trained by receiving a set of inputs along with the corresponding correct outputs. To employ supervised learning, the machine learning module 131 may store a labelled dataset for learning, a dataset for testing and a final dataset from which the machine learning module 131 may use for making suggestions or predictions about the files and data that has been analyzed by the analytics engine 129.

The machine learning algorithms may learn by comparing the actual output with the correct outputs in order to find errors. The machine learning module 131 may modify the model of data according to the correct outputs to refine the decision making of the machine learning module 131, improving the accuracy of the automated decision making of the machine learning module 131 to provide the correct inputs, in this case to correcting characterize the itinerary data 142 in order to retrieve each rule that may be relevant from the rules engine 123. During the training phase, the machine learning module 131 may learn the correct outputs by analyzing and describing well known data and information, that may be stored by the data input repository 121. Examples of data modeling that may be used by the machine learning module 131, may include classification, regression, prediction and gradient boosting.

Unsupervised learning techniques on the other hand may be used when there may be a lack of historical data that may be available to compare current itinerary data 142 with a previous set of labelled itinerary data. Machine learning that is unsupervised may not be “told” the right answer the way supervised learning algorithms do. Instead, during unsupervised learning, the algorithm may explore the data to find a common properties and attributes between the files being explored. Embodiments of an unsupervised learning algorithm can identify common attributes between a plurality of itineraries stored by the data input repository 121, based on the itinerary data 142 contained by each itinerary. Examples of unsupervised machine learning may include self-organizing maps, nearest-neighbor mapping, k-means clustering, and singular value decomposition.

Embodiments of a machine learning module 131 may also incorporate semi-supervised learning techniques in some situations. Semi-supervised learning may be used for the same applications as supervised learning. However, instead of using entirely labelled training examples of data during the training phase, there may be a mix of labelled and unlabeled examples during the training phase. Semi-supervised learning may be ideal when there is a small or limited amount of labelled data being used as examples (i.e., there may be a small amount of historical data describing previously analyzed itineraries) alongside a larger amount of unlabeled data that may be presented to the machine learning module 131 during the training phase. Suitable types of machine learning techniques that may use semi-supervised learning may include classification, regression and prediction models.

Using the analysis of the itinerary data 142, the analytics engine 129 may submit a query to the rules engine 123 describing one or more parameters of the itinerary data 142. In response to the query, the rules engine 123 may scan the rule data 161 stored by the rules repository 125 for criteria that matches the parameters of the itinerary data 142 and return one or more sets of rules that may be applicable to the traveler's itinerary. Based on the query submitted to the rules engine 123 and the responding set of rules returned to the analytics engine 129, embodiments of the analytics engine 129 may create a set of rule requirements specifically tailored toward the travel plans described by traveler's itinerary, including one or more specific steps that may be required to be completed before the execution of the itinerary, in order to fulfill one or more rules, laws or regulations to access each of the locations scheduled by the itinerary.

Embodiments of the analytics engine 129 may further utilize AI algorithms and/or machine learning techniques to compare the document data 145 uploaded by a traveler or a third party to the secure storage repository 140 against the rule requirements for the location or region scheduled to be accessed by the traveler. The analytics engine 129 may cross reference the required supporting documentation as established by the rule requirements with the uploaded document data 145 to determine which types of document data 145 might still be absent. Moreover, the analytics engine 129 may further analyze the supporting documents uploaded to the secure storage repository 140 to determine whether or not the document data 145 of the supporting documents is sufficient and complete for each document uploaded. Based on the analysis of the supporting documentation, the analytics engine 129 may track the progress of a traveler toward meeting each of the goals set forth by the rule requirements and generate a remediation report 570 describing the traveler's progress and shortcomings. Embodiments of the reporting engine 135 may perform the function or task of delivering and/or displaying the remediation report 570 to the traveler via a touchscreen display 117 of the analysis system 101 or a traveler's device 143 connected to the analysis system 101 via network 150.

Referring to the drawings, FIG. 5c and FIG. 6c depict an example of a remediation report 570. Embodiments of the remediation report 570 may summarize the scheduled itinerary and describe the traveler's progress toward meeting each of the rule requirements for the locations or regions scheduled to be accessed by the traveler. Embodiments of the remediation report 570 may provide relevant information describing the traveler's progress, including a brief summary of each rule that the traveler should be in compliance with prior to enacting the scheduled itinerary, the status of each rule requirement as complete or incomplete, one or more remediation steps to comply with each of the incomplete rule requirements, a probability of completing each incomplete rule requirement within the timing requirements set forth within the scheduled itinerary and a target date initiating the performance of the remediation step in order to achieve the predicted probability of completion.

In some embodiments, the analytics engine 129 may generate a proposed timeline for performing one or more remediation steps which may optimize the total amount of time necessary to complete all of the rule requirements, particularly in a scenario where one or more remediation steps may be dependent upon completing another remediation step first. Embodiments of the timeline may comprise one or more remediation steps target dates, an estimated timeframe for completing a remediation step based on the processing time data 157, and the expected date for receiving a formal completion communication from the authority responsible for processing the remediation step transaction. As new and revised document data 145 is uploaded to the secure storage repository 140, the analytics engine 129 may update the remediation report 570 and amend the projected timeline in view of the new and revised document data 145 received.

The embodiment of the remediation report 570 depicted in FIG. 5c provides an example of a remediation report 570 that may be provided by the analysis system 101 to guide a traveler toward meeting the rule requirements within the deadlines of the itinerary of FIG. 5a. The remediation report 570 example is generated in response to the document data 145 uploaded via the interface of the traveler device 143 to a secure storage repository 140 (such as a blockchain 141) as shown in FIG. 5b. Based on the analysis of the documents provided in FIG. 5b, the analytics engine 129 has identified and reported, via the remediation report 570 depicted in FIG. 5c, that two of the rule requirements for accessing Germany in accordance with the itinerary of FIG. 5a have not been met. The first requirement that is flagged as being inadequate in this example, is the requirement by Germany that a US passport should be valid for at least 6 months after departing the country. A second inadequacy of the uploaded passport is also identified based on the rules of the layover country of France which requires a US passport to be issued within the last 10 years. The remediation step recommended to the traveler by the analysis system 101 is for the traveler to renew the traveler's US passport.

In the example of FIG. 5c, embodiments of the analytics engine 129 may accurately predict the probability of successfully completing the passport renewal process using machine learning techniques and a collection of historical processing time data 157 for completing a US passport renewal which may have been gathered from processing system 155 or data source 159 such as the US department of state, a US agency responsible for the processing of US passports. In this particular example, since there are several months remaining prior to the execution of the scheduled itinerary, the analytics engine 129 could estimate that a passport renewal has a high probability of being successful, as demonstrated by the 95% probability of being completed prior to the Dec. 1, 2018 travel date, if the renewal request is submitted by Sep. 15, 2018. Once the passport renewal has been completed, the traveler may upload the newly received passport document data 145 to the secure storage repository 140. The analytics engine 129 may reanalyze the renewed passport and confirm whether or not the passport's document data 145 now meets the rule requirements that were previously failed and the reporting engine 135 may update and deliver the updated remediation report 570 to the traveler's device 143.

In some embodiments of the analysis system 101, the analytics engine 129 may calculate the probabilities of successfully meeting the rule requirements by performing one or more simulations via a simulation module 133. Embodiments of the simulation module 133 may utilize statistical methods and computerized modeling using the timing requirements of the scheduled itinerary, processing time data 157 for each transaction that may still be outstanding in the remediation report 570 in order to perform a plurality of simulations, while tracking the success or failure of each simulation. The simulation module 133 may not only track a plurality of different targeting dates to identify the best proposed timeline for completing each of the rule requirements, but the simulations may additionally test various changes in the remediation recommendations to further identify the remediation steps that could be recommended that may provide a traveler with the highest probability of fulfilling each of the rule requirements prior to the deadlines set by the scheduled itinerary.

In some instances, the calculated probability for completing a remediation step may be below a threshold probability that would be considered acceptable to the analysis system 101 or the traveler. A probability of completion that is lower than the threshold may be calculated in instances when the processing time data 157 may suggest that may take longer to complete a transaction described by a remediation step than an amount of time that may be available before the scheduled itinerary is implemented. In response to the probability being considered low or lower than a threshold probability, the analysis system 101 may recommend additional remediation steps, which may include delaying travel dates to a recommended date that would provide ample time to complete one or more remediation steps, or make suggested modifications to transportation or travel routes that might remove one or more rule requirements (i.e. flying directly to a foreign country instead of having a layover in a second foreign country that might impose additional rule requirements that may not be able to be completed in time). Any projected timelines that may have been proposed by the analytics engine 129 as part of the remediation report 570 and may be modified in view of one or more amendments to the scheduled itinerary and represented to the traveler via the reporting engine 135.

Method for Tracking and Validating Access Requirements

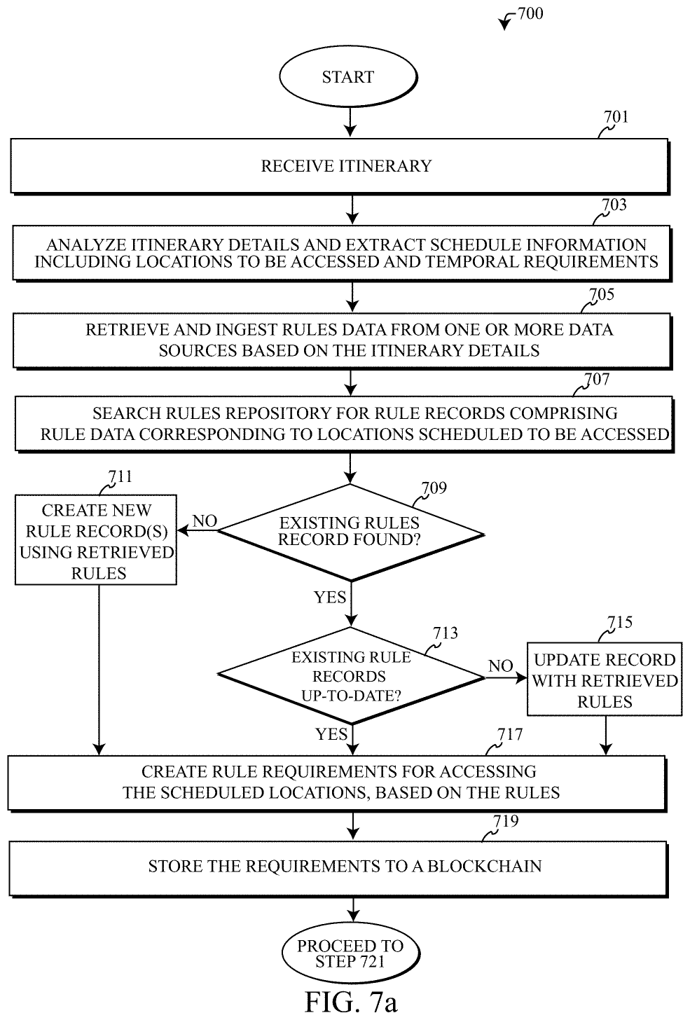

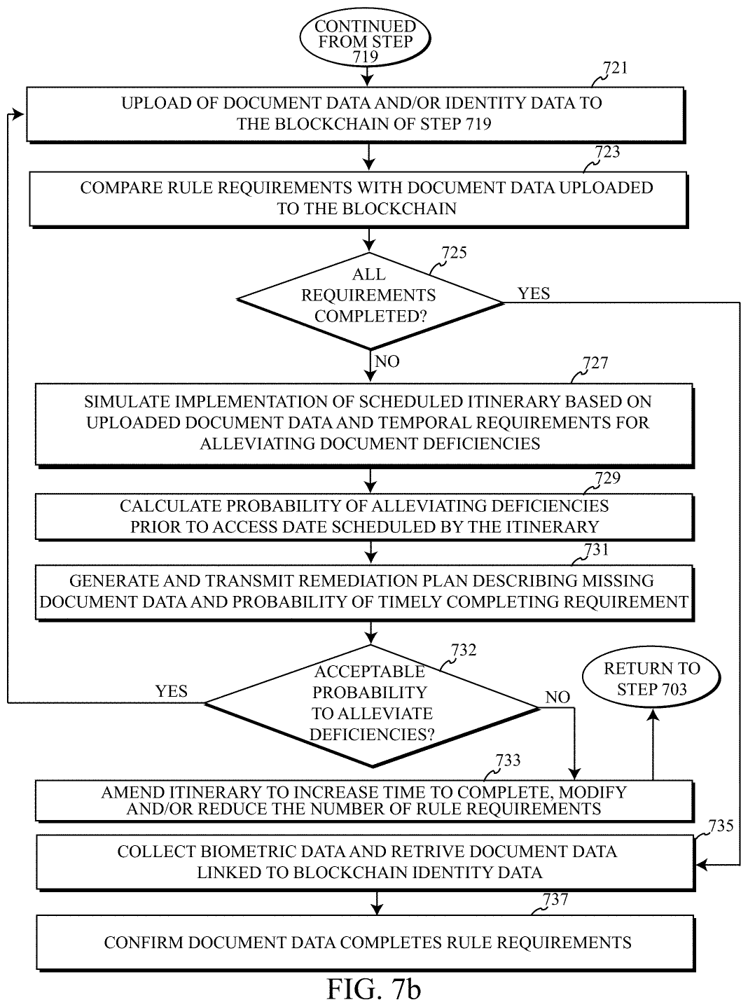

The drawings of FIG. 7a-7b represent embodiments of an algorithm 700 for implementing computerized-methods for tracking and validating requirements for accessing a restricted or regulated location, as described in FIGS. 1-6c using one or more computer systems as defined generically by computer system 800 of FIG. 8 below and more specifically by the embodiments of specialized computer systems, such as the analysis system 101, traveler device 143 or verification device 151, depicted in FIGS. 1-6c and as described herein. A person skilled in the art should recognize that the steps of the method described in FIGS. 7a-7b may be performed in a different order than presented and the methods of FIGS. 7a-7b may not require all the steps described herein to be performed. Rather, some embodiments may alter the methods by using one or more of the steps discussed below.

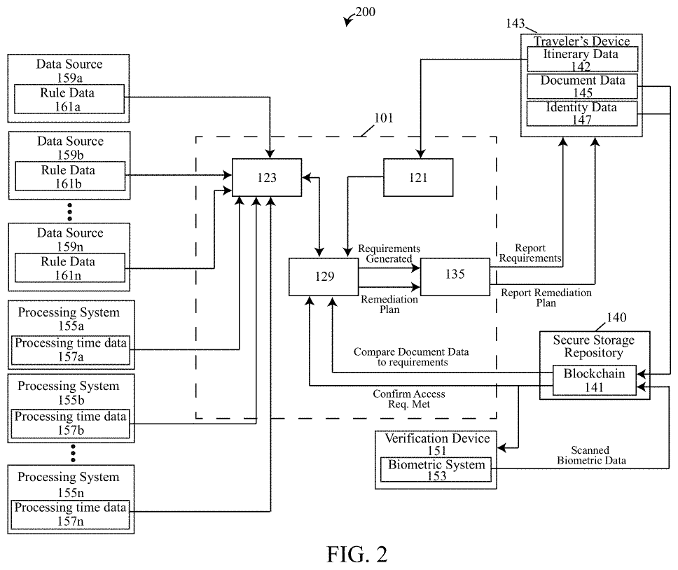

FIG. 7a represents a flowchart illustrating a first portion of an algorithm 700 for implementing a computerized method for tracking and validating access requirements in accordance with the embodiments of the present disclosure. The embodiment of the algorithm 700 may begin at step 701. In step 701, an analysis system 101 may receive an itinerary from a traveler device 143, wherein said itinerary may be created by a traveler operating the traveler device 143 or directly inputted into the analysis system 101. As shown by the embodiment of FIG. 2 depicting the workflow of algorithm 700, the traveler's device 143 may be transmitted as itinerary data 142 to the data input repository 121 where the itinerary data may be further stored, processed and analyzed in subsequent steps of the algorithm 700. One or more fields of the itinerary data 142 may be organized and formatted into a database record, allowing for queries about one or more fields described by the itinerary data 142 to be searched, recalled, updated, deleted and amended by the traveler or one or more components of the analysis system 101.

In step 703 of algorithm 700, the analytics engine 129 of the analysis system 101 may analyze one or more details of the itinerary received in step 701. The analytics engine 129 may extract scheduling information from the itinerary and store the scheduling information in the data input repository 121. The scheduling information may include travel dates and times the itinerary has scheduled the traveler to enter, exit, or access one or more locations (timing requirements) as well as the location data such as routes, regions or locations of origin, regions or locations being entered, including any scheduled layovers or events being experienced in the layover locations. Moreover, the itinerary details may further include personalized information describing the traveler, including name, address, residence, country of citizenship, immigration status, and family members or children of a specified age that may be accompanying the traveler, etc.

Based on the itinerary details and personalized information describing the traveler, in step 705, the rules engine 123 may retrieve one or more sets of rules data 161 relevant to the itinerary details for one or more regions or locations being visited or traveled through by the traveler. The rules data 161 may be retrieved from one or more data sources 159 that may be responsible for maintaining the rules for a particular region or location. For example, an official government website responsible for travel and tourism may post the legal and regulatory requirements for gaining access to the interior of a particular country. As shown by the embodiment of FIG. 2, each data source 159a, 159b . . . 159n, in a plurality of data sources 159 may provide a rule data 161a, 161b . . . 161n that may be retrieved from more than one data source 159 as shown. Embodiments of the rules engine 123 may analyze or parse through the data source 159 describing the laws, rules and regulations and store the laws, rules or regulations in one or more repositories such as rules repository 125 of the rules engine 123.

In step 707 of algorithm 700, the rules engine 123 may search the rules repository 125 for any existing records describing the laws, rules, and regulations currently of record within the analysis system 101, that may be applicable to the regions or locations described by the itinerary data 142 which the currently scheduled itinerary indicates will be accessed on a date or time consistent with the timing requirements of scheduled itinerary. In step 709, a determination may be made whether or not a current set of existing rules exist in the rules repository 125. If, there are no existing records for the rules associated with the regions or locations of the scheduled itinerary, the algorithm 700 may proceed to step 711, wherein the rules engine 123 may create one or more rule records for each region or location scheduled to be accessed, based on the rules retrieved in step 705.

Conversely, if in step 709, the determination is made that there is already an existing set of rules for the region or location described by the scheduled itinerary, the rules engine 123 may proceed to step 713 and make a second determination, directed toward whether or not the existing rules recorded in the rules repository 125 are currently up-to-date. A comparison may be made by the rules engine 123 to determine which set of rules is more recent, the set of rules retrieved in step 705 or the existing rules recorded in the rules repository 125. If the rules retrieved by the rules engine 123 in step 705 are more current than the existing record of the rules repository 125, the algorithm may proceed to step 715, wherein the rules engine 123 may update the record of the rules repository 125 to reflect the rules retrieved during step 705 and delete any rules that may be part of the record that may be expired or no longer valid. If, however, in step 713 it is determined by the rules engine 123 that the existing rules record of the rules repository 125 is more recent, complete and/or up-to-date than the rules accessed by the rules engine 123 in step 705, the algorithm 700 may proceed to step 717.

In step 717 of algorithm 700, the analytics engine 129 may create rule requirements for accessing the regions or locations of the scheduled itinerary. The rule requirements may be created based on the rules recorded in the rules repository 125 for each region or location scheduled in the itinerary to be visited or accessed by the traveler, including any regions or locations that a traveler may pass through or experience a layover during transit to a final destination. In step 719, the rule requirements created in step 717 may be stored within a secured storage repository 140. For example, the rule requirements may be stored by a blockchain 141, which may be securely accessed by providing one or more secured credentials when attempting to access the blockchain 141. For example, in some embodiments, the blockchain 141 may be secured using one or more sets of identity data 147 provided by the traveler to the analysis system 101. Subsequent access to the blockchain 141 may be authorized by supplying identity data 147 to the blockchain 141 at the time the data stored to the blockchain 141 or as document data 145 is seeking to be accessed by a third party. In some embodiments, the identity data 147 required to access the blockchain's 141 stored data may be traveler biometric data. For example, by scanning a traveler's fingerprint, iris, retina, face, signature, writing pattern, movements or any other biometric data that may confirm the identity of the traveler and match identity data 147 stored by the blockchain 141.

In step 721, upon storing the rule requirements to the blockchain 141, the analysis system 101 may enable the traveler's device 143 to upload document data 145 and/or identity data 147 to the blockchain 141 or other secure storage repository 140. The blockchain 141 or other secure storage repository 140 may be secured via the identity data 147, wherein the blockchain 141 may require the identity data 147 to access the document data 145 being uploaded. In the case of blockchain 141, the traveler device 143 may transmit the document data 145 via network 150 to the secure storage repository 140 containing the blockchain 141. Document data 145 may be retrieved from the blockchain 141 or another secure storage repository 140 by the analysis system 101 via network 150. The analysis system 101 may store the document data 145 in the data input repository 121 in some embodiments. The document data 145 being stored may be linked to the scheduled itinerary record of the data input repository 121.

In some embodiments, the rule requirements and the document data 145 may be loaded into the analytics engine 129. In step 723, the analytics engine 129 may compare the rule requirements with the document data 145 that has been uploaded to the blockchain 141 or other secure storage repository 140. The analytics engine 129 may analyze the document data 145 to confirm that the document data 145 provided is complete, and that no mandatory fields of the supporting documentation, as required by the rules of the region or location have been omitted from the document data 145 uploaded to the blockchain 141. Moreover, the analytics engine 129 may track the progress of submitting each piece of documentation prescribed by the rule requirements.

In step 725 of algorithm 700, the analytics engine 129 may make a determination whether all the rule requirements have been completed. If each rule required to be complied with in accordance with each region's laws, rules and regulations, the traveler may be considered ready to implement the scheduled itinerary as entered and stored by the data input repository 121. The algorithm may proceed to step 735 (described below), wherein the traveler implements the scheduled itinerary by physically arriving at a region or location prescribed by the itinerary for further action by an authorized agent or third-party actor interacting with the traveler to further confirm that each of the rules, laws and regulations have been complied with to access the region or location being visited.

Conversely, if in step 725, a determination is made by the analytics engine 129 that all of the rule requirements have not been completed, the analytics engine 129 may run one or more simulations using the rule requirements, the timing requirements of the scheduled itinerary and the document data 145 currently provided, to identify which document data 145 has still not been uploaded by the traveler and calculate a probability that a traveler will still be able to comply with each of the rule requirements before the date and time the itinerary is currently scheduled to be implemented. The one or more simulations performed by the simulation module 133 of the analytics engine 129 may be performed using actual processing time data 157 maintained by governments and agencies that may be responsible for providing the requisite documentation and approvals for the traveler to access the region or locations of the scheduled itinerary. For instance, the issuing authorities of a country's visa programs, passport issuing authority, local counties that maintain birth certificate records etc. The analytics engine 129 may scrape processing time data 157 from one or more agencies that may be needed by the traveler to complete a task in order to calculate a timeframe a traveler may be able to receive documentation from the authority responsible for issuing the documentation.

For example, a traveler may be traveling from the US to another country, and one of the steps of the rule requirements may include the traveler having a valid passport. At the time of uploading the document data 145 to the blockchain 141, the traveler's passport might be expired. During the simulation step, the simulation module 133 may consider the time required to re-issue the valid passport, in view of the amount of time remaining before the scheduled itinerary is implemented (i.e. the travel date) to identify whether the simulation will succeed or fail and consider any alternative steps or permutations that may be known by the analytics engine 129 that may provide an increased probability of success (i.e. expedited processing, modifying the itinerary, amending travel dates, etc.). The analytics engine 129 may retrieve a recent set of processing time data 157 from a processing system 155 that may be responsible for processing and issuing the documentation requests. In this example, the passport re-issue request for an expired passport would be the US Department of State. Embodiments of the analytics engine 129 may retrieve processing time data 157 describing actual processing times for cases pending and completed by the authority responsible for processing and completing a task required by the rule requirements. By scraping a set of processing time data 157, the analytics engine 129 may calculate the average processing time in order to predict how long a task may take to complete. In some embodiments, the analytics engine 129 may scrape processing time data 157 that may be more recent or within a pre-defined time period which may be more accurate to the processing times a traveler may realize by submitting a documentation request in the near future as opposed to processing times that may have been relevant 10 years ago. Based on the number of successful simulations and the number of failed simulations performed in step 727, in step 729 the analytics engine 129 may calculate a probability that a traveler may alleviate each of the current rule requirement deficiencies prior to the date of implementing the scheduled itinerary.

In step 731 of algorithm 700, the reporting engine 135 may generate a remediation report 570 to help the traveler identify and track the document data 145 that may still be missing or incomplete that is preventing the completion of the rule requirements as well as identify the probability of completing the rule requirements prior to the implementation of the scheduled itinerary. In some embodiments, the remediation report 570 may offer suggestions for completing the rule requirements within the timing requirements imposed by the scheduled itinerary. For example, the remediation report 570 may identify that fulfilling certain requirements may be dependent upon first obtaining a particular set of documents which may need to be submitted to obtain a subsequent document. The remediation report 570 may suggest the order of fulfilling requirements to optimize the fulfillment of the rule requirements and increase the overall probability of completing the rule requirements prior to implementing the scheduled itinerary. Moreover, the remediation report may further suggest extra options that may be available for completing one or more rule requirements. For example, certain documents may be obtained more quickly by expediting the process or applying for rush processing. The remediation report 570 may take these extra expedited options into account when performing the simulations in step 727 and probabilities with and without the expedited options may be displayed by the remediation report generated being displayed by the reporting engine 135.

In some embodiments of algorithm 700, an acceptable level of risk, as measured by the probability of completing the rule requirements prior to the implementation of the scheduled itinerary may be acceptable to the analysis system 101 and/or the traveler. In some embodiments, the traveler or the analytics engine 129 may set a pre-determined acceptable probability of success, wherein if the remediation report 570 does not identify a probability of successfully completing the rule requirements with a probability above the acceptable threshold, other actions may be implemented to raise the probability levels. For example, a determination may be made in step 732 by comparing the probability of completing the rule requirements as described by the remediation report in step 731 with the acceptable probability defined by the traveler and/or the analysis system 101. If the probability of completing the rule requirements is above the threshold level, the remediation report 570 may be presented to the traveler and the algorithm 700 may return to step 721, wherein the traveler may continue to pursue and upload one or more documents as document data 145 to the blockchain 141. Otherwise, if the level of probability described in the remediation report 570 is below the threshold level, the algorithm 700 may proceed to step 733.

In step 733, an action may be performed to the itinerary that may increase the probability or alleviate one or more rule requirements that may be hindering a traveler's ability to complete the rule requirements within the currently scheduled itinerary. In some embodiments, the itinerary may be amended by delaying the date of accessing a region or location (i.e. delaying a travel date) to provide more time to complete the rule requirements. In another embodiment, the travel plans, regions or locations scheduled to be accessed may be altered or removed to eliminate one or more rule requirements. For example, while traveling between two countries, a traveler may be scheduled to layover in a third country that may have onerous rule requirements and/or lengthy processing times. The traveler and/or the analysis system 101 may remediate the issues caused by the layover country by rerouting travel plans to avoid the country entirely, thus avoiding the onerous rule requirements and fulfilling each of the rule requirements of the modified itinerary. The algorithm 700 may then return back to step 703 and re-analyze the itinerary based on the amended itinerary and re-determine the rule requirements that may be necessary to complete prior to the amended itinerary date of implementation.

Once all of the document data 145 has been uploaded to the blockchain 141 or other secure storage repository 140 as described in step 723, and the rule requirements are determined by the analytics engine 129 to be completed, the algorithm may proceed to step 735. In step 735, the traveler may physically travel to each location or region in accordance with the scheduled itinerary. Along each stop in the itinerary, one or more agents, authorities or third-party actors may be authorizing access to the location or region. In step 735, the agent, authority or third-party actors may request access to the document data 145 stored by the blockchain 141 or other secure storage repository 140, in order to permit access to the location or region. The agent, authority or third-party actor may use one or more biometric systems 153 to collect biometric data from the traveler presenting themselves at the location or region scheduled by the itinerary. The biometric data collected by the biometric system 153 may be matched to the identity data 147 linked to the blockchain 141 or secure storage repository 140. In step 737, upon accessing the blockchain 141 via the secure storage repository 140, the agent, authority or third-party actor may verify each piece of document data 145 uploaded to the blockchain 141 that is relevant to the location or region wherein the traveler is located or on their way to accessing. Based on the uploaded document data 145 being accessible, the agent, authority or third-party actor responsible for granting access to the region or location may confirm whether or not the document data 145 completes each of the rule requirements for the particular location or region the traveler may be seeking access to, and either grant or deny access based on compliance with the rules, laws and regulations.

Computer System

FIG. 8 is a block diagram of internal and external components of a computer system 800, which may be representative of the one or more computer systems depicted in the computing environment 100, 200 as shown in FIGS. 1-2 in accordance with the embodiments of the present disclosure. It should be appreciated that FIG. 8 provides only an illustration of one implementation and does not imply any limitations with regard to the environments in which different embodiments may be implemented. In general, the components illustrated in FIG. 8 are representative of any electronic device capable of executing machine-readable program instructions. Examples of computer systems, environments, and/or configurations that may be represented by the components illustrated in FIG. 8 include, but are not limited to, personal computer systems, server computer systems, thin clients, thick clients, laptop computer systems, tablet computer systems, cellular telephones (e.g., smart phones), multiprocessor systems, microprocessor-based systems, network PCs, minicomputer systems, mainframe computer systems, and distributed cloud computing environments that include any of the above systems or devices.

Computer system 800 may include communications fabric 802, which provides for communications between one or more processors 103, memory 105, persistent storage 106, communications unit 111, and one or more input/output (I/O) interfaces 113. Communications fabric 802 can be implemented with any architecture designed for passing data and/or control information between processors 103 (such as microprocessors, communications and network processors, etc.), system memory 105, external devices 115, and any other hardware components within a system. For example, communications fabric 802 can be implemented with one or more buses.

Memory 105 and persistent storage 106 may be computer-readable storage media. Embodiments of memory 105 may include random access memory (RAM) 107 and cache 109 memory. In general, memory 105 can include any suitable volatile or non-volatile computer-readable storage media. Software, such as a program 821 may be stored in persistent storage 106 for execution and/or access by one or more of the respective processors 103 via one or more devices of memory 105.

Persistent storage 106 may include, for example, a plurality of magnetic hard disk drives. Alternatively, or in addition to magnetic hard disk drives, persistent storage 106 can include one or more solid state hard drives, semiconductor storage devices, read-only memories (ROM), erasable programmable read-only memories (EPROM), flash memories, or any other computer-readable storage media that is capable of storing program instructions or digital information. Embodiments of the media used by persistent storage 106 can also be removable. For example, a removable hard drive can be used for persistent storage 106. Other examples include optical and magnetic disks, thumb drives, and smart cards that are inserted into a drive for transfer onto another computer-readable storage medium that is also part of persistent storage 106.

Communications unit 111 provides for communications with other computer systems or devices via a network (e.g., network 150). In the exemplary embodiment, communications unit 111 may include network adapters or interfaces such as a TCP/IP adapter cards, wireless Wi-Fi interface cards, 3G, 4G, or 5G wireless interface cards or other wired or wireless communication links. The network 150 can comprise, for example, copper wires, optical fibers, wireless transmission, routers, firewalls, switches, gateway computers and/or edge servers. Software and data used to practice embodiments of the present invention can be downloaded to each of the computer systems operating in computing environment 100, 200 or computer system 800 through communications unit 111 (e.g., via the Internet, a local area network or other wide area network). From communications unit 111, the software and data can be loaded onto persistent storage 106.

One or more I/O interfaces 113 may allow for input and output of data with other devices that may be connected to computer system 800. For example, I/O interface 113 can provide a connection to one or more external devices 115 such as one or more audio systems 205, video systems, sensor devices, input devices such as a keyboard, computer mouse, touch screen, virtual keyboard, touch pad, pointing device, or other human interface devices. External devices 115 can also include portable computer-readable storage media such as, for example, thumb drives, portable optical or magnetic disks, and memory cards. I/O interface 113 may also connect to touchscreen display 117. Touchscreen display 117 provides a mechanism to display data to a traveler and can be, for example, a computer monitor or screen. Touchscreen Display 117 can also be an incorporated display and may function as a touch screen, such as a built-in display of a tablet computer.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the traveler's computer, partly on the traveler's computer, as a stand-alone software package, partly on the traveler's computer and partly on a remote computer or entirely on the remote computer or server. In the latter scenario, the remote computer may be connected to the traveler's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising the steps of:
analyzing a scheduled itinerary for timing requirements and location information;
ingesting rule data describing rules corresponding to the location information;
creating a set of rule requirements based on the rule data;
comparing each document submitted by a traveler with the rule requirements; and
generating a remediation report comprising a description of each document that fails to comply with the rule requirements and a remediation recommendation for complying with the rule requirements.

2. The computer-implemented method of claim 1, wherein each document submitted by a traveler is uploaded to a blockchain.

3. The computer-implemented method of claim 2, wherein access to each document stored by the blockchain is restricted using identity data of the traveler, wherein the identity data comprises biometric data.

4. The computer-implemented method of claim 1, further comprising the steps of:
retrieving processing time data;
calculating an average processing time for implementing the remediation recommendation to comply with the rule requirements; and
creating a projected timeline using the average processing time to predict compliance of the rule requirements within the timing requirements of the scheduled itinerary.

5. The computer-implemented method of claim 1 further comprising the steps of:
simulating a completion of the rule requirements within the timing requirements of the scheduled itinerary using the remediation report; and
calculating a probability of completing the rule requirements as a function of the simulating step.

6. The computer-implemented method of claim 5, further comprising the steps of:
identifying the probability of completing the rule requirements within the timing requirements of the scheduled itinerary as being less than a threshold level of probability;
amending the scheduled itinerary; and
amending the remediation report as a function of the amended scheduled itinerary.

7. The computer-implemented method of claim 3, further comprising the step of:
scanning the traveler for biometric data;
matching the scanned biometric data to the identity data stored by the blockchain;
retrieving, from the blockchain, each document submitted by the traveler; and
confirming completion of the rule requirements based on each document present in the blockchain.

8. A computer system comprising:
a processor; and
a computer-readable storage media coupled to a processor, wherein the computer readable storage media contains program instructions executing a computer-implemented method comprising the steps of:
analyzing a scheduled itinerary for timing requirements and location information;
ingesting rule data describing rules corresponding to the location information;
creating a set of rule requirements based on the rule data;
comparing each document submitted by a traveler with the rule requirements; and
generating a remediation report comprising a description of each document that fails to comply with the rule requirements and a remediation recommendation for complying with the rule requirements.

9. The computer system of claim 8, wherein each document submitted by a traveler is uploaded to a blockchain.

10. The computer system of claim 9, wherein access to each document stored by the blockchain is restricted using identity data of the traveler, wherein the identity data comprises biometric data.

11. The computer system of claim 8, wherein the computer-implemented method further comprises the steps of:
retrieving processing time data;
calculating an average processing time for implementing the remediation recommendation to comply with the rule requirements; and
creating a projected timeline using the average processing time to predict compliance of the rule requirements within the timing requirements of the scheduled itinerary.

12. The computer system of claim 8, wherein the computer-implemented method further comprises the steps of:
simulating a completion of the rule requirements within the timing requirements of the scheduled itinerary using the remediation report; and
calculating a probability of completing the rule requirements as a function of the simulating step.

13. The computer system of claim 12, wherein the computer-implemented method further comprises the steps of:
identifying the probability of completing the rule requirements within the timing requirements of the scheduled itinerary as being less than a threshold level of probability;
amending the scheduled itinerary; and
amending the remediation report as a function of the amended scheduled itinerary.

14. The computer system of claim 10, wherein the computer-implemented method further comprises the steps of:
scanning the traveler for biometric data;
matching the scanned biometric data to the identity data stored by the blockchain;
retrieving, from the blockchain, each document submitted by the traveler; and
confirming completion of the rule requirements based on each document present in the blockchain.

15. A computer program product comprising:
one or more computer readable storage media having computer-readable program instructions stored on the one or more computer readable storage media, said program instructions executes a computer-implemented method comprising the steps of:
analyzing a scheduled itinerary for timing requirements and location information;
ingesting rule data describing rules corresponding to the location information;
creating a set of rule requirements based on the rule data;
comparing each document submitted by a traveler with the rule requirements; and
generating a remediation report comprising a description of each document that fails to comply with the rule requirements and a remediation recommendation for complying with the rule requirements.

16. The computer program product of claim 15, wherein each document submitted by a traveler is uploaded to a blockchain.

17. The computer program product of claim 16, wherein access to each document stored by the blockchain is restricted using identity data of the traveler, wherein the identity data comprises biometric data.

18. The computer program product of claim 15, wherein the computer-implemented method further comprises the steps of:
retrieving processing time data;
calculating an average processing time for implementing the remediation recommendation to comply with the rule requirements; and
creating a projected timeline using the average processing time to predict compliance of the rule requirements within the timing requirements of the scheduled itinerary.

19. The computer program product of claim 15, wherein the computer-implemented method further comprises the steps of:
simulating a completion of the rule requirements within the timing requirements of the scheduled itinerary using the remediation report;
calculating a probability of completing the rule requirements as a function of the simulating step;
identifying the probability of completing the rule requirements within the timing requirements of the scheduled itinerary as being less than a threshold level of probability;
amending the scheduled itinerary; and
amending the remediation report as a function of the amended scheduled itinerary.

20. The computer program product of claim 17, wherein the computer-implemented method further comprises the steps of:
scanning the traveler for biometric data;
matching the scanned biometric data to the identity data stored by the blockchain;
retrieving, from the blockchain, each document submitted by the traveler; and
confirming completion of the rule requirements based on each document present in the blockchain.
